(19) United States
(12) Patent Application Publication
(10) Pub. No.: US 2025/0375994 A1
(43) Pub. Date: Dec. 11, 2025

(54) USING ROAD PREVIEW TO TEMPORARILY ADJUST HEIGHT FOR APPROACHING OBSTACLE

(71) Applicant: GM Global Technology Operations LLC, Detroit, MI (US)

(72) Inventors: Brian K. Saylor, South Lyon, MI (US); Matthew Watts, South Lyon, MI (US); Robert Patrick Marble, White Lake, MI (US)

(73) Assignee: GM Global Technology Operations LLC, Detroit, MI (US)

(21) Appl. No.: 18/740,228

(22) Filed: Jun. 11, 2024

(51) Int. Cl. B60G 17/0165

(52) U.S. Cl. CPC B60G 17/0165; B60G 2400/204; B60G 2400/258; B60G 2401/14; B60G 2500/30

(57) ABSTRACT

A system and method for using road preview to temporarily adjust height for an approaching obstacle includes receiving road preview data detected by a sensor system of a vehicle, the road preview data indicating an anomaly in a path of the vehicle. Here, the anomaly is disposed above a top surface of the path of the vehicle. The system and method also include estimating, based on the road preview data indicating the anomaly, attributes of the anomaly and determining, based on a velocity of the vehicle, a distance between the vehicle and the anomaly, and the attributes of the anomaly, whether a projected impact with the anomaly exceeds a vehicle travel threshold, and when the projected impact with the anomaly exceeds the vehicle travel threshold, raising the suspension of the vehicle from an initial height to a target height.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to systems and methods of using road preview data to temporarily adjust a vehicle suspension height for an approaching obstacle. Generally, when a vehicle is moving, the vehicle receives road preview data and may recognize an upcoming object with positive displacement in the path of the vehicle. For example, the road preview data may indicate that bumps, debris, and/or other road hazards that are above-grade (i.e., on top of the path) are in the path of the vehicle. When the vehicle impacts the object, any energy not absorbed by the tires and the shock absorbers may travel into the vehicle and jolt the vehicle, its cargo, and its passengers. Notably, the speed of the vehicle, the distance between the vehicle and the upcoming object, and the size and shape of the object all affect how aggressive the impact will be.

While existing suspension systems adequately dampen impacts between vehicles and objects, risk of damage to the vehicle is ever present. Further, proactive measures using predictive algorithms to further limit peak force from the impact may prolong the life of the suspension system, reduce damage to the vehicle, and increase passenger comfort when traveling in the vehicle.

### SUMMARY

One aspect of the disclosure provides a computer-implemented method for using road preview to temporarily adjust vehicle height for an approaching obstacle that when executed on data processing hardware causes the data processing hardware to perform operations that include receiving road preview data detected by a sensor system of a vehicle, the road preview data indicating an anomaly in a path of the vehicle, the anomaly disposed above a top surface of the path of the vehicle. The operations also include estimating, based on the road preview data indicating the anomaly, attributes of the anomaly and determining, based on a velocity of the vehicle, a distance between the vehicle and the anomaly, and the attributes of the anomaly, whether a projected impact with the anomaly exceeds a vehicle travel threshold. When the projected impact with the anomaly exceeds the vehicle travel threshold, the operations further include raising a suspension of the vehicle from an initial height to a target height.

Implementations of the disclosure may include one or more of the following optional features. In some implementations, raising the suspension of the vehicle from the initial height to the target height includes raising the suspension to reach the target height before the vehicle reaches the anomaly in the path of the vehicle. In some examples, the target height of the suspension is higher than a height of the anomaly. In some implementations, the target height of the suspension is configured to maximize a jounce travel of the suspension.

In some examples, the sensor system includes one or more of cameras, radio detection and ranging (RADAR), and light detection and ranging (LIDAR). In some implementations, the attributes of the anomaly include one or more of a height of the anomaly and a slope angle of the anomaly. In some examples, the operations further include lowering the suspension of the vehicle from the target height to the initial height after the vehicle passes the anomaly in the path of the vehicle.

In some implementations, the operations further include selecting the target height of the suspension of the vehicle based on whether the attributes of the anomaly exceed a maximum jounce travel of the vehicle. In these implementations, the operations may further include, when the attributes of the anomaly exceed the maximum jounce travel of the vehicle, assigning the maximum jounce travel of the vehicle as the target height of the suspension of the vehicle. Alternatively, these operations may further include, when the attributes of the anomaly do not exceed the maximum jounce travel, assigning a height of the anomaly as the target height of the suspension of the vehicle.

Another aspect of the disclosure provides a system using road preview to temporarily adjust vehicle height for an approaching obstacle that includes data processing hardware and memory hardware in communication with the data processing hardware. The memory hardware stores instructions that when executed by the data processing hardware cause the data processing hardware to perform operations that include receiving road preview data detected by a sensor system of a vehicle, the road preview data indicating an anomaly in a path of the vehicle, the anomaly disposed above a top surface of the path of the vehicle. The operations also include estimating, based on the road preview data indicating the anomaly, attributes of the anomaly and determining, based on a velocity of the vehicle, a distance between the vehicle and the anomaly, and the attributes of the anomaly, whether a projected impact with the anomaly exceeds a vehicle travel threshold. When the projected impact with the anomaly exceeds the vehicle travel threshold, the operations further include raising a suspension of the vehicle from an initial height to a target height.

This aspect may include one or more of the following optional features. In some implementations, raising the suspension of the vehicle from the initial height to the target height includes raising the suspension to reach the target height before the vehicle reaches the anomaly in the path of the vehicle. In some examples, the target height of the suspension is higher than a height of the anomaly. In some implementations, the target height of the suspension is configured to maximize a jounce travel of the suspension.

In some examples, the sensor system includes one or more of cameras, radio detection and ranging (RADAR), and light detection and ranging (LIDAR). In some implementations, the attributes of the anomaly include one or more of a height of the anomaly and a slope angle of the anomaly. In some examples, the operations further include lowering the suspension of the vehicle from the target height to the initial height after the vehicle passes the anomaly in the path of the vehicle.

In some implementations, the operations further include selecting the target height of the suspension of the vehicle based on whether the attributes of the anomaly exceed a maximum jounce travel of the vehicle. In these implementations, the operations may further include, when the attributes of the anomaly exceed the maximum jounce travel of the vehicle, assigning the maximum jounce travel of the vehicle as the target height of the suspension of the vehicle. Alternatively, these operations may further include, when the attributes of the anomaly do not exceed the maximum jounce travel, assigning a height of the anomaly as the target height of the suspension of the vehicle.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system using road preview to temporarily adjust height for an approaching obstacle.

FIG. 2 is a schematic view of example components of the system of FIG. 1.

FIGS. 3A and 3B are schematic views of a vehicle temporarily adjusting a suspension height for an approaching obstacle using the system of FIG. 1.

FIG. 4 is a suspension model flowchart for the system of FIG. 1.

FIG. 5 is a flowchart of an example arrangement of operations for a method of using road preview to temporarily adjust height for an approaching obstacle.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

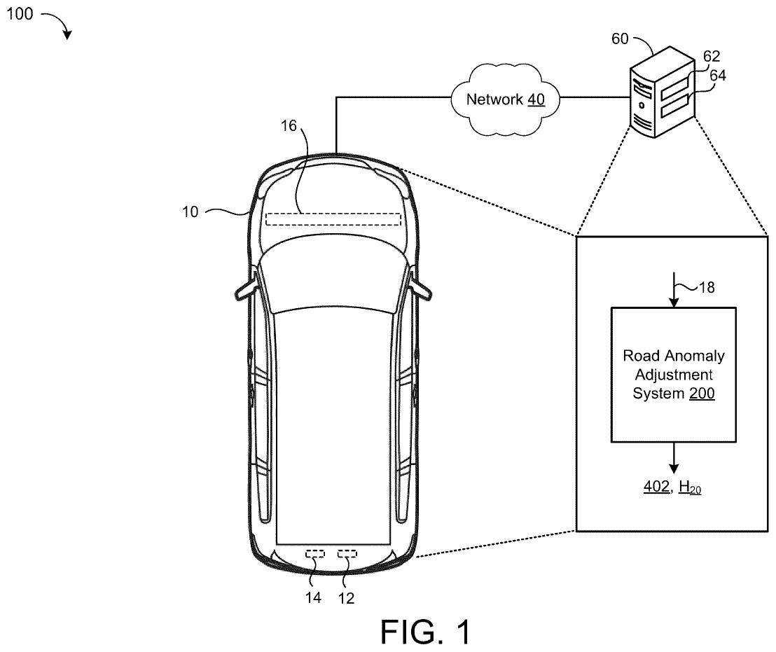

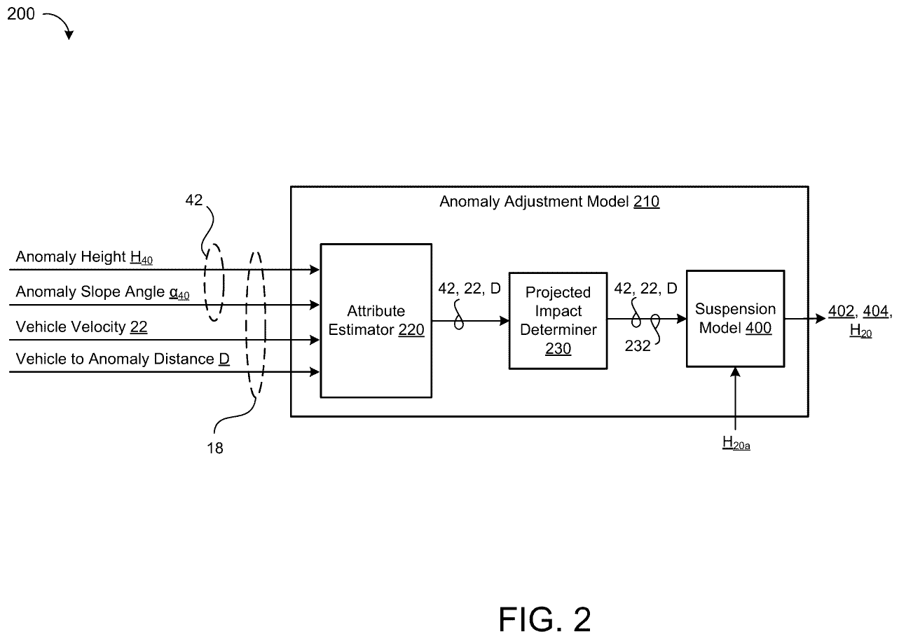

Referring to FIG. 1, in some implementations, a system 100 includes a vehicle 10 and/or a remote system 60 in communication with the vehicle 10 via a network 40. The vehicle 10 and/or the remote system 60 execute a road anomaly adjustment system 200 (FIG. 2) configured to capture road preview data 18 and temporarily adjust a height H₂₀ of a suspension 20 of the vehicle 10. Briefly, and described in further detail below, the road anomaly adjustment system 200 receives the road preview data 18 indicating an anomaly 40 in a path 30 of the vehicle 10 and, based on the road preview data 18, raises the suspension 20 of the vehicle 10 from an initial height H₂₀ₐ to a target height H_{20b} to maximize the effective jounce travel of the suspension 20 while minimizing the energy transmitted into the vehicle 10, cargo of the vehicle 10, and passengers within the vehicle 10 at the time that the vehicle 10 impacts the anomaly 40. Moreover, raising the height H₂₀ of the suspension 20 actively protects the suspension 20, and therefore prolongs the life of the suspension system 20, as well as reduces damage to the wheels and body of the vehicle 10.

In the examples shown, the road anomaly adjustment system 200 is implemented within the vehicle 10. However, the road anomaly adjustment system 200 can be implemented on other computing devices (e.g., computing devices in communication with the vehicle 10), such as, without limitation, a smart phone, tablet, smart display, desktop/laptop, smart watch, smart appliance, or smart glasses/headset. The vehicle 10 includes data processing hardware 12 and memory hardware 14 storing instructions that when executed on the data processing hardware 12 cause the data processing hardware 14 to perform operations. The vehicle 10 further includes a sensor system 16 configured to capture/receive road preview data 18. The sensor system 16 may include one or more long range radar sensors and/or one or more camera sensors capable of capturing image data. For example, the sensor system 16 may include one or more of cameras, radio detection and ranging (RADAR), and light detection and ranging (LIDAR). In some implementations, the sensor system 16 additionally receives third-party data published by other vehicles 10, the third-party data indicating upcoming obstacles.

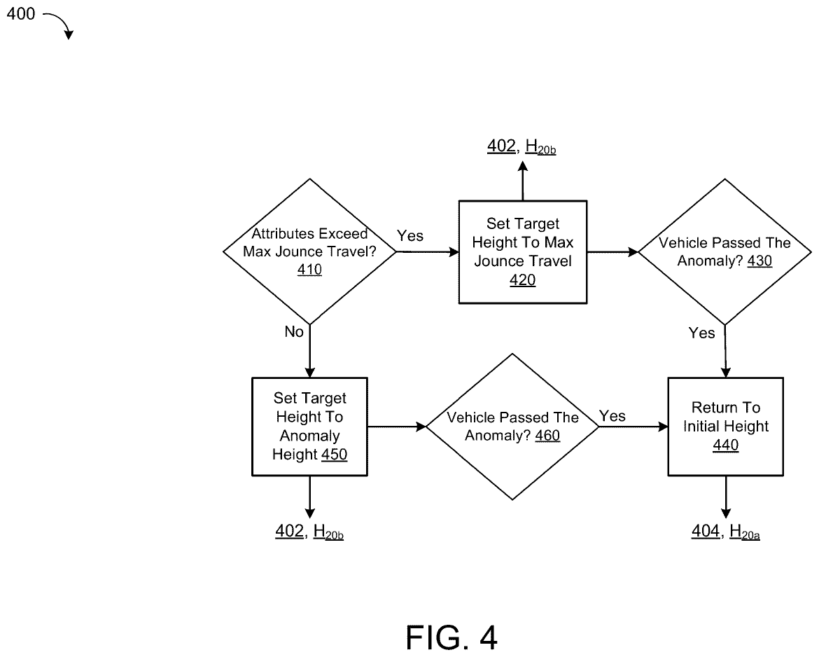

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the road anomaly adjustment system 200 is shared across the vehicle 10 and the remote system 60. As described in greater detail below with reference to FIGS. 2-4, the road anomaly adjustment system 200 executing on the vehicle 10 and/or the remote system 60 executes an anomaly adjustment model 210 including an attribute estimator 220, a projected impact determiner 230, and a suspension model 400 (FIG. 4). The system 200 is configured to receive the road preview data 18 detected by the sensor system 16—indicating an anomaly 40 that the vehicle 10 will impact—and the initial height H₂₀ₐ of the suspension 20, and generate a target height H_{20b} of the suspension 20 to minimize the impact between the vehicle 10 and the anomaly 40.

Referring to FIGS. 1-3B, while the vehicle 10 is moving, the vehicle 10 executes the road anomaly adjustment system 200 that receives, as input, road preview data 18 detected by the sensor system 16 of the vehicle 10. As shown, the vehicle 10 is traveling on a path 30. The path 30 may correspond to a paved roadway, an unpaved roadway, or off-road, and includes a top surface 32 on which the vehicle 10 is disposed. The path 30 may generally define a range or distance beyond the vehicle 10 where the road anomaly adjustment system 200 detects anomalies (also referred to as obstacles) such as bumps, debris, or other objects disposed on or above the top surface 32 of the path 30. In other words, the road anomaly adjustment system 200 detects positive road obstacles (i.e., above grade) as anomalies 40.

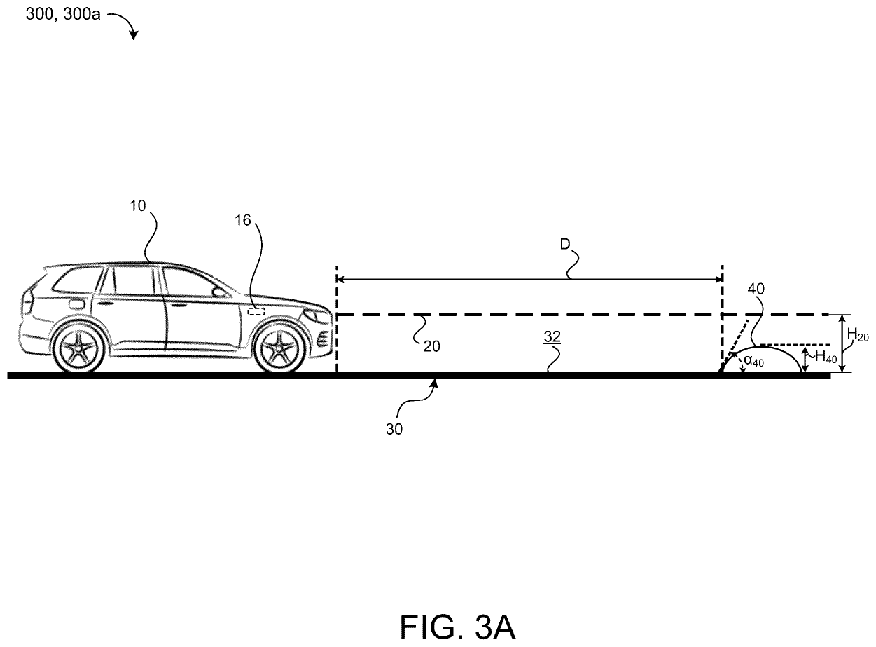

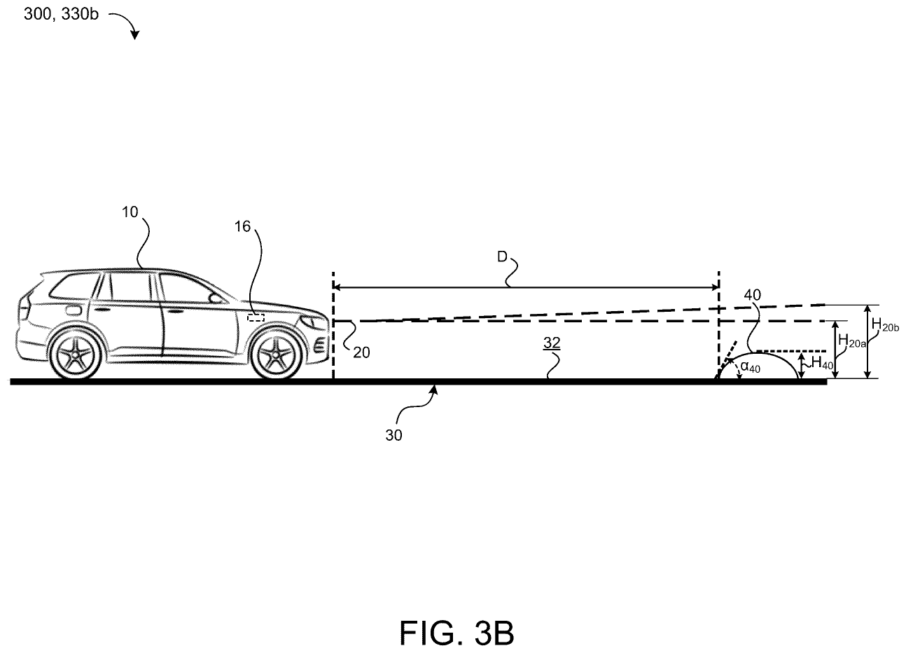

With particular reference to FIGS. 2-3B, the anomaly adjustment model 210 receives the road preview data 18 and determines that the road preview data 18 indicates that an anomaly 40 is in the path 30 of the vehicle 10. In particular, the road preview data 18 indicates that the anomaly 40 is disposed above the top surface 32 of the path 30 of the vehicle 10, and that the vehicle 10 will make contact with/hit the anomaly 40 in its current trajectory. In response to determining that the road preview data 18 indicates that the anomaly 40 is in the path 30 of the vehicle 10, the attribute estimator 220 of the anomaly adjustment model 210 may estimate, based on the road preview data 18, attributes 42 of the anomaly 40. For example, the attributes 42 may include a height H₄₀ of the anomaly 40, and/or a slope angle α₄₀ (i.e., indicating the steepness) of the anomaly 40. In some implementations, the road preview data 18 may further include a current velocity 22 of the vehicle 10, and a distance D between the vehicle 10 and the anomaly 40.

Notably, the height H₄₀ of the anomaly 40 and/or the slope angle do of the anomaly 40 may modify the compression in both the tires of the vehicle 10 and the suspension 20 of the vehicle 10, thereby modifying the projected impact 232 between the vehicle 10 and the anomaly 40. For example, an anomaly 40 with a high height H₄₀ (e.g., a 6 (six) inch log) may cause greater compression in the tires and the suspension 20 of the vehicle 10. Similarly, when the slope angle do of the anomaly 40 is particularly high (e.g., 80 degrees), the compression in the tires and the suspension 20 of the vehicle 10 may exceed the limits of the shock absorption within the suspension 20 such that a jolt is transferred to passengers or cargo in the vehicle 10.

After estimating the attributes 42 of the anomaly 40 and/or the velocity 22 of the vehicle 20 and the distance D between the vehicle 10 and the anomaly 40, the projected impact determiner 230 of the anomaly adjustment model 210 determines a projected impact 232 between the vehicle 10 and the anomaly 40. For example, the projected impact determiner 230 may receive, as input, the attributes 42 of the anomaly 40 including the height H₄₀ of the anomaly 40 and/or the slope angle α₄₀ of the anomaly 40, the velocity 22 of the vehicle 10, and the distance D between the vehicle 10 and the anomaly 40, and predict, as output, a projected impact 232 between the vehicle 10 and the anomaly 40 at the current velocity 22 of the vehicle. The projected impact determiner 230 may compare the projected impact 232 to a vehicle travel threshold. The vehicle travel threshold may be derived from a calibration table that associates attributes 42 (i.e., the H₄₀ and/or the slope angle α₄₀) of anomalies 40 with current velocities 22 of vehicles 10, and may vary depending on the particular make and model of the vehicle 10.

When the projected impact 232 with the anomaly 40 exceeds the vehicle travel threshold, the suspension model 400 may raise the suspension 20 of the vehicle 10. For example, the suspension 20 may raise the height H₂₀ of the suspension 20 from an initial height H₂₀ₐ to a target height H_{20b}. The suspension model 400 may raise the suspension 20 of the vehicle 10 from the initial height H₂₀ₐ to the target height H_{20b} before the vehicle 10 reaches the anomaly 40 in the path 30 of the vehicle 10. Here, the suspension model 400 may raise the suspension 20 of the vehicle 10 at a raise rate 402 that causes the suspension 20 to reach the target height H_{20b} before the vehicle 10 has traveled the distance D between the vehicle 10 and the anomaly 40. In some implementations, the raise rate 402 is 12 millimeters (mm)/second(s). However, it should be understood that the raise rate 402 may be configured to be lower (e.g., 5 mm/s) or higher (e.g., 25.4 mm/s) depending on the particular vehicle 10 and the anomaly 40 while minimizing disruption to the passengers of the vehicle 10. In implementations where the projected impact 232 with the anomaly 40 does not exceed the vehicle travel threshold, the suspension model 400 may maintain the height H₂₀ of the suspension 20 and continue to receive and monitor the road preview data 18 for additional anomalies 40.

In implementations where the suspension model 400 raises the suspension 20 of the vehicle 10 from the initial height H₂₀ₐ to the target height H_{20b}, after the vehicle 10 passes the anomaly 40 in the path 30 of the vehicle 10, the suspension model 400 may lower the suspension 20 of the vehicle 10 from the target height H_{20b} to the initial height H₂₀ₐ. Here, the suspension model 400 may lower the vehicle 10 at a lower rate 404 to return the height H₂₀ of the suspension 20 to the initial height H₂₀ₐ. In these implementations, the lower rate 404 may be the same as the raise rate 402 to minimize jostling of the vehicle 10. For example, the raise rate 402 and the lower rate 404 may both be 12 mm/s. Alternatively, the lower rate 404 may be consistent (e.g., always 12 mm/s) while the raise rate 402 is variable depending on the projected impact 232 between the vehicle 10 and the anomaly 40.

With particular reference to FIGS. 3A and 3B, environments 300a, 300b show the vehicle 10 driving on the path 30 as it approaches an anomaly 40 disposed on the top surface 32 in the path 30 of the vehicle 10. In FIG. 3A, the suspension 20 of the vehicle 10 is at the initial height H₂₀ₐ. In response to detecting the anomaly 40 and receiving the attributes 42 of the anomaly 40, the velocity 22 of the vehicle 10, and the distance D between the vehicle 10 and the anomaly 40, the projected impact determiner 230 may determine that a projected impact 232 between the vehicle 10 and the anomaly 40 exceeds the vehicle travel threshold. In FIG. 3B, after determining that the projected impact 232 between the vehicle 10 and the anomaly 40 exceeds the vehicle travel threshold, the suspension model 400 may determine a target height H_{20b}, and initiate raising the suspension 20 from the initial height H₂₀ₐ to the target height H_{20b} at a raise rate 402 necessary to minimize the impact between the vehicle 10 and the anomaly by maximizing the effective jounce travel of the suspension 20. In some implementations, the target height H_{20b} of the suspension 20 is higher than the height H₄₀ of the anomaly 40.

Referring to FIG. 4, the suspension model 400 of the anomaly adjustment model 210 is shown. Here, the suspension model 400 receives the attributes 42 of the anomaly 40 including the height H₄₀ of the anomaly 40 and/or the slope angle quo of the anomaly 40, the velocity 22 of the vehicle 10, the distance D between the vehicle 10 and the anomaly 40, and the projected impact 232. The suspension model 400 is configured to maximize the jounce travel of the suspension 20. In other words, the suspension model 400 may raise the height H₂₀ of the suspension 20 vertically to increase the vertical compression the suspension 20 may absorb before transferring energy from the impact between the vehicle 10 and the anomaly 40 into the vehicle 10, cargo, and passengers of the vehicle 10.

At operation 410, the suspension model 400 determines whether the attributes 42 of the anomaly 40 exceed a maximum jounce travel of the vehicle 10. The maximum jounce travel may be derived from a calibration table that associates attributes 42 (i.e., the H₄₀ and/or the slope angle α₄₀) of anomalies 40 with current velocities 22 of vehicles 10, and may vary depending on the particular make and model of the vehicle 10. Here, the suspension model 400 may select the target height H_{20b} of the suspension 20 of the vehicle 10 based on whether the attributes 42 of the anomaly 40 exceed the maximum jounce travel of the vehicle 10.

When the attributes 42 (e.g., the height H₄₀ of the anomaly 40 and/or the slope angle α₄₀ of the anomaly 40) exceed the maximum jounce travel of the vehicle 10, at operation 420, the suspension model 400 may assign the maximum jounce travel of the vehicle 10 as the target height H_{20b} of the suspension 20 of the vehicle 10. For example, the suspension model 400 may determine a time to impact by dividing the distance D between the vehicle 10 and the anomaly 40 by the velocity 22 of the vehicle 10. Here, if the raise rate 402 multiplied by the time to impact is greater than the target height H_{20b} (i.e., the maximum jounce travel of the vehicle 10), then the suspension model 400 may proceed with raising the suspension 20 to the target height H_{20b} at the raise rate 402. If the raise rate 402 multiplied by the time to impact is less than the target height H_{20b} (i.e., the maximum jounce travel of the vehicle 10), then the suspension model 400 may identify that raising the suspension 20 will not be successful. Here, the suspension model 400 may proceed with raising the suspension 20 to the target height H_{20b} at the raise rate 402, despite the fact that the suspension 20 will not reach the target height H_{20b} in the time to impact. In other words, even in implementations where the suspension 20 will not reach the target height H_{20b} in the time to impact, any additional height H₂₀ of the suspension 20 achieved by raising the suspension 20 at the raise rate 402 will provide an improved impact between the vehicle 10 and the anomaly 40 than if the suspension 20 is not raised at all. Alternatively, the suspension model 400 may not modify the height H₂₀ of the suspension 20 if the suspension 20 will not reach the target height H_{20b} in the time to impact. At operation 430, the suspension model 400 determines whether the vehicle 10 passed the anomaly 40. In particular, whether the vehicle 10 has moved beyond the anomaly 40. When the vehicle 10 has passed the anomaly 40, the suspension model, at operation 440 lowers the suspension 20 from the target height H_{20b} (i.e., the maximum jounce travel of the vehicle 10) to the initial height H₂₀ₐ at the lower rate 404.

Alternatively, when the attributes 42 (e.g., the height H₄₀ of the anomaly 40 and/or the slope angle α₄₀ of the anomaly 40) do not exceed the maximum jounce travel of the vehicle 10, at operation 450, the suspension model 400 may assign the height H₄₀ of the anomaly 40 as the target height H_{20b} of the suspension 20 of the vehicle 10. For example, the suspension model 400 may determine a time to impact by dividing the distance D between the vehicle 10 and the anomaly 40 by the velocity 22 of the vehicle 10. Here, if the raise rate 402 multiplied by the time to impact is greater than the target height H_{20b} (i.e., the height H₄₀ of the anomaly 40), then the suspension model 400 may proceed with raising the suspension 20 to the target height H206 at the raise rate 402. If the raise rate multiplied by the time to impact is less than the target height H_{20b} (i.e., the height H₄₀ of the anomaly 40), then the suspension model 400 may identify that raising the suspension 20 will not be successful. Here, the suspension model 400 may proceed with raising the suspension 20 to the target height H_{20b} at the raise rate 402, despite the fact that the suspension 20 will not reach the target height H_{20b} in the time to impact. Alternatively, the suspension model 400 may not raise the height H₂₀ of the suspension 20 if the suspension 20 will not reach the target height H_{20b} in the time to impact. At operation 460, the suspension model 400 determines whether the vehicle 10 passed the anomaly 40. In particular, whether the vehicle 10 has moved beyond the anomaly 40. When the vehicle 10 has passed the anomaly 40, the suspension model, at operation 440 lowers the suspension 20 from the target height H_{20b} (i.e., the height H₄₀ of the anomaly 40) to the initial height H₂₀ₐ at the lower rate 404.

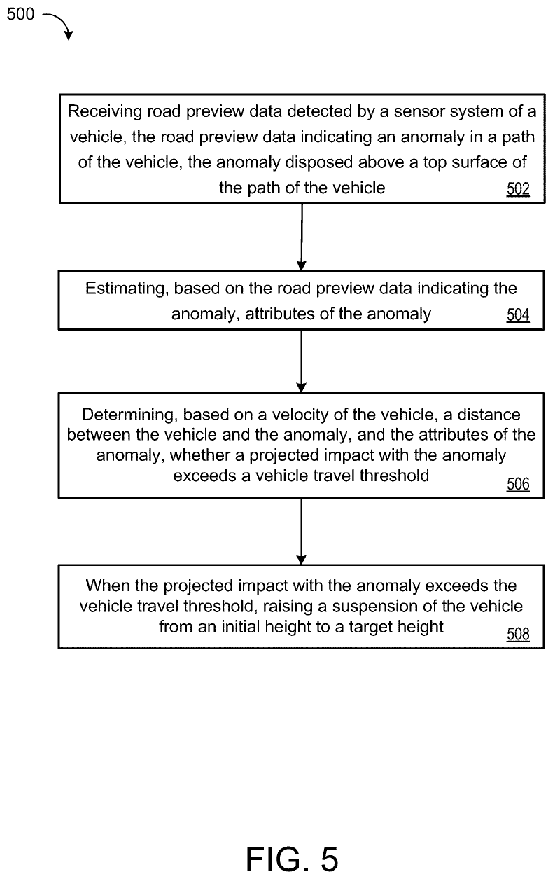

FIG. 5 includes a flowchart of an example arrangement of operations for a method 500 of using road preview to temporarily adjust height for an approaching obstacle. The method 500 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 500.

At operation 502, the method 500 includes receiving road preview data 18 detected by a sensor system 16 of a vehicle 10. The road preview data 18 indicates an anomaly 40 in a path 30 of the vehicle 10, the anomaly 40 disposed above a top surface 32 of the path 30 of the vehicle 10. At operation 504, the method 500 also includes estimating, based on the road preview data 18 indicating the anomaly 40, attributes 42 of the anomaly 40.

The method 500 also includes, at operation 506, determining, based on a velocity 22 of the vehicle 10, a distance D between the vehicle 10 and the anomaly 40, and the attributes 42 of the anomaly 40, whether a projected impact 232 with the anomaly 40 exceeds a vehicle travel threshold. When the projected impact 232 with the anomaly 40 exceeds the vehicle travel threshold, the method 500 further includes, at operation 508, raising a suspension 20 of the vehicle 10 from an initial height H₂₀ₐ to a target height H_{20b}.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving road preview data detected by a sensor system of a vehicle, the road preview data indicating an anomaly in a path of the vehicle, the anomaly disposed above a top surface of the path of the vehicle;
estimating, based on the road preview data indicating the anomaly, attributes of the anomaly;
determining, based on a velocity of the vehicle, a distance between the vehicle and the anomaly, and the attributes of the anomaly, whether a projected impact with the anomaly exceeds a vehicle travel threshold, the vehicle travel threshold derived from a calibration table that associates a plurality of different attributes of anomalies with a plurality of different vehicle velocities, the calibration table being specific to a make and model of the vehicle; and
when the projected impact with the anomaly exceeds the vehicle travel threshold, raising a suspension of the vehicle from an initial height to a target height.

2. The method of claim 1, wherein raising the suspension of the vehicle from the initial height to the target height comprises raising the suspension to reach the target height before the vehicle reaches the anomaly in the path of the vehicle.

3. The method of claim 1, wherein the target height of the suspension is higher than a height of the anomaly.

4. The method of claim 1, wherein the target height of the suspension is configured to maximize a jounce travel of the suspension.

5. The method of claim 1, wherein the sensor system comprises one or more of:
cameras;
radio detection and ranging (RADAR); and
light detection and ranging (LIDAR).

6. The method of claim 1, wherein the attributes of the anomaly comprise one or more of a height of the anomaly and a slope angle of the anomaly.

7. The method of claim 1, wherein the operations further comprise lowering the suspension of the vehicle from the target height to the initial height after the vehicle passes the anomaly in the path of the vehicle.

8. The method of claim 1, wherein the operations further comprise selecting the target height of the suspension of the vehicle based on whether the attributes of the anomaly exceed a maximum jounce travel of the vehicle.

9. The method of claim 8, wherein the operations further comprise, when the attributes of the anomaly exceed the maximum jounce travel of the vehicle, assigning the maximum jounce travel of the vehicle as the target height of the suspension of the vehicle.

10. The method of claim 8, wherein the operations further comprise, when the attributes of the anomaly do not exceed the maximum jounce travel, assigning a height of the anomaly as the target height of the suspension of the vehicle.

11. A system comprising:
data processing hardware; and
memory hardware in communication with the data processing hardware, the memory hardware storing instructions that when executed on the data processing hardware cause the data processing hardware to perform operations comprising:
receiving road preview data detected by a sensor system of a vehicle, the road preview data indicating an anomaly in a path of the vehicle, the anomaly disposed above a top surface of the path of the vehicle;
estimating, based on the road preview data indicating the anomaly, attributes of the anomaly;
determining, based on a velocity of the vehicle, a distance between the vehicle and the anomaly, and the attributes of the anomaly, whether a projected impact with the anomaly exceeds a vehicle travel threshold, the vehicle travel threshold derived from a calibration table that associates a plurality of different attributes of anomalies with a plurality of different vehicle velocities, the calibration table being specific to a make and model of the vehicle; and
when the projected impact with the anomaly exceeds the vehicle travel threshold, raising a suspension of the vehicle from an initial height to a target height.

12. The system of claim 11, wherein raising the suspension of the vehicle from the initial height to the target height comprises raising the suspension to reach the target height before the vehicle reaches the anomaly in the path of the vehicle.

13. The system of claim 11, wherein the target height of the suspension is higher than a height of the anomaly.

14. The system of claim 11, wherein the target height of the suspension is configured to maximize a jounce travel of the suspension.

15. The system of claim 11, wherein the sensor system comprises one or more of:
cameras;
radio detection and ranging (RADAR); and
light detection and ranging (LIDAR).

16. The system of claim 11, wherein the attributes of the anomaly comprise one or more of a height of the anomaly and a slope angle of the anomaly.

17. The system of claim 11, wherein the operations further comprise lowering the suspension of the vehicle from the target height to the initial height after the vehicle passes the anomaly in the path of the vehicle.

18. The system of claim 11, wherein the operations further comprise selecting the target height of the suspension of the vehicle based on whether the attributes of the anomaly exceed a maximum jounce travel of the vehicle.

19. The system of claim 18, wherein the operations further comprise, when the attributes of the anomaly exceed the maximum jounce travel of the vehicle, assigning the maximum jounce travel of the vehicle as the target height of the suspension of the vehicle.

20. The system of claim 18, wherein the operations further comprise, when the attributes of the anomaly do not exceed the maximum jounce travel, assigning a height of the anomaly as the target height of the suspension of the vehicle.
